(19) United States
(12) Patent Application Publication
(10) Pub. No.: US 2012/0289423 A1
(43) Pub. Date: Nov. 15, 2012

(54) ONLINE REAL-TIME WATER QUALITY MONITORING AND CONTROL SYSTEM INCORPORATING SYSTEMS FOR AUTOMATED MICROBIOLOGICAL TESTING AND ONE-STEP DNA DETECTION

(76) Inventors: Michael Kane, West Lafayette, IN (US); Bruce Applegate, West Lafayette, IN (US); Sergei Savikhin, West Lafayette, IN (US); James Walsh, Kuala Lumpur (MY); Paul Duffy, Dublin (IE); Gerry Woods, Dublin (IE)

(21) Appl. No.: 13/465,777

(22) Filed: May 7, 2012

Related U.S. Application Data
(60) Provisional application No. 61/482,971, filed on May 5, 2011.

(51) Int. Cl. C40B 40/06; C40B 30/04; G01N 21/64

(52) U.S. Cl. 506/9; 435/6.11; 506/16

(57) ABSTRACT

A system for detecting deoxyribonucleic acid (DNA) biomarkers. The system is configured to monitor and control standard parameters (temperature, pH, free chlorine, redox potential, TDS, turbidity), via an array of sensors. The system is configured to perform automated microbiological testing using a DNA hybridization based optical detection sensor, wherein the sensor is configured to provide automated sample collection, primer and buffer addition, thermocycling and fluorescence detection via laser excitation and a linear CCD.

### RELATED APPLICATION

This application is related to, and claims the priority benefit of, U.S. Provisional Patent Application Ser. No. 61/482,971, filed May 5, 2011, the contents of which are hereby incorporated into the present disclosure in their entirety.

### FEDERALLY SPONSORED RESEARCH

This invention was made with government support under 59-1935-8-850 awarded by USDA. The government has certain rights in the invention.

### BACKGROUND

Reliable water monitoring and control systems are becoming increasingly important to ensure reliable water quality for the public and also for monitoring and control of industrial run off. The development of a modular water monitoring and control system would provide a standard operational platform that can be easily modified and employed across numerous applications.

In addition, detecting deoxyribonucleic acid (DNA) biomarkers is an important feature in many areas dealing with biomolecules. In particular, detection schemes directed to both qualitative (i.e., detecting the presence of one or more DNA biomarkers), and quantitative (i.e., where an absolute or relative amount of DNA is present within a sample) is important. Furthermore, detecting one or more changes or differences in DNA sequences, such as single nucleotide polymorphisms is also desirable.

Deoxyribonucleic acid (DNA) microarray detection is a widely used molecular biological technique. Equivalent in size to a standard laboratory slide, these microarrays include “printed” chains of the constituent molecules of DNA which include Adenine, Thymine, Cytosine, and Guanine. The ordering of molecules in these chains, or probes, determines what target strains of DNA they will bind to. One common mode of operation involves a fluorophore and a quencher molecule being attached at either end of the probes. Tension in the probe causes it to form into a “hairpin” loop, positioning the fluorophore and quencher molecules beside each other. Excitation of the microarray by a laser will cause no fluorescence when no target DNA is present due to fluorescence resonance energy transfer (FRET) between the fluorophore and quencher, as known to a person of ordinary skill in the art. However, when a target strand of DNA is bound to the probe, the hairpin loop is forced open separating the fluorophore and quencher molecules. When excited by laser light, the fluorescence occurs due to the lack of FRET caused by the separation of the fluorophore and quencher molecules. While highly successful, this method has some drawbacks, especially when trying to fully automate such a process. Light will be emitted only when an undamaged fluorophore is present. Should no light be emitted under excitation, lack of emitted light may mean either the target DNA is not present and light is not being emitted due to the action of the quencher molecule, or target DNA is present but no light is being emitted due to damage occurring to the fluorophore. There is inherent risk in this method of obtaining false negatives, limiting its application in fully automated systems.

Therefore, a system for detecting biomolecular structures such as DNA biomarkers in an automated or semiautomated fashion is needed.

### SUMMARY

The present disclosure includes disclosure of systems and methods for detecting deoxyribonucleic acid (DNA) biomarkers. In at least one embodiment, such a system is configured to monitor and control standard parameters (temperature, pH, free chlorine, redox potential, TDS, turbidity), via an array of sensors. In at least one embodiment, such a system may be configured to provide online data logging and remote control. In at least one embodiment, such a system may be configured to perform automated microbiological testing using a DNA hybridization based optical detection sensor, wherein the sensor is configured to provide automated sample collection, primer and buffer addition, thermocycling, and fluorescence detection via laser excitation and a linear CCD.

The present disclosure includes disclosure of methods for detecting DNA biomarkers. In at least one embodiment, such a method comprises the steps of loading a volume of amplification reagents into an automated detection device; entering at least one control parameter into the automated detection device; loading a sample into the detection device; mixing the sample with the amplification reagents to create a reaction volume; conducting at least one thermal cycle on the reaction volume; hybridizing the reaction volume to the at least one dual-fluorescent oligonucleotide probe; detecting a fluorescence emission, wherein the at least one dual-fluorescent oligonucleotide probe hybridized to the reaction volume is excited by a laser and emits a fluorescence detected by an emission detector; logging data from the fluorescence emission; analyzing the data from the fluorescence emission; automatically cleaning the automated detection device; and conducting a verification test, wherein at least one dual-fluorescent oligonucleotide probe is excited by a laser and emits a fluorescence detected by an emission detector. In an aspect of at least one embodiment of the present disclosure, the foregoing steps are repeated at least one time. In at least one embodiment of the present disclosure, a method for detecting DNA biomarkers comprises a step of conducting a second verification test prior to loading a sample. In at least one embodiment of the present disclosure, a method for detecting DNA biomarkers utilizes a reaction volume of at least 100 μl. In at least one embodiment of the present disclosure, a method for detecting DNA biomarkers utilizes red or green fluorescence. In at least one embodiment of the present disclosure, in a method for detecting DNA biomarkers a step of automatically cleaning an automated detection device occurs concurrently with a step of conducting at least one thermal cycle on a reaction volume and a step of detecting a fluorescence emission. In at least one embodiment of the present disclosure, a method for detecting DNA biomarkers comprises a step of holding a reaction volume at a detection temperature to hybridize the reaction volume to at least one dual-fluorescent oligonucleotide probe. In at least one embodiment of the present disclosure, a method for detecting DNA biomarkers comprises a step of automatically cleaning the automated detection device comprising three discrete cleaning cycles.

The present disclosure includes disclosure of an automated DNA detection device. In at least one embodiment, such an automated DNA detection device comprises top clamp having an optical aperture; a microarray slide connected below the top clamp, the microarray slide comprising at least one dual-labeled fluorescent oligonucleotide probe, wherein the optical aperture of the top clamp allows for a fluorescence emission of at least one dual-labeled fluorescent oligonucleotide probe and emission detection by an emission detector; a reaction chamber connected to the microarray slide, the reaction chamber comprising a reaction volume; a thermoelectric module connected to the reaction chamber, wherein the thermoelectric module is capable of heating or cooling the reaction volume; a water block connected to the thermoelectric module, wherein the water block and the thermoelectric module operate to perform at least one thermal cycle; a fluidic system in communication with the water block, thermoelectric module, reaction chamber, laser, and emission detector, wherein the fluidic system comprises at least one reservoir, waste chamber, cooling system, valve, pump, and sensor operably connected to one another to control the flow of at least one fluid through the fluidic system, wherein at least one sensor can detect the flow of at least one fluid within the fluidic system and provide at least one feedback communication to the emission detector; and a bottom clamp operably connected to the top clamp to secure the microarray slide, reaction chamber, thermoelectric module, water block, and fluidic system to one another. In at least one embodiment of the present disclosure, an automated DNA detection device comprises a fluidic system comprising three reservoirs. In at least one embodiment of the present disclosure, an automated DNA detection device comprises at least one feedback communication comprising at least one of the following: a quality control communication, a self-cleaning communication, and/or a probe verification communication. In at least one embodiment of the present disclosure, an automated DNA detection device is reusable.

### BRIEF DESCRIPTION OF DRAWINGS

FIG. 1 shows an optical detection scheme according to at least one embodiment of the present disclosure utilizing detection probes and a linear charged coupled device (CCD) array.

FIG. 2 shows a graph which depicts conversion of raw barcode data via image analysis to graphical representation of the barcode data.

FIG. 3 shows a schematic of at least one embodiment of the system according to the present disclosure that utilizes a specialized microarray that includes dual-labeled fluorescent oligonucleotide probes, which fluoresces red in the absence of sequence-specific binding using fluorescence resonance energy transfer (FRET), and fluoresces green in the presence of sequence-specific binding (due to the disruption of FRET).

FIG. 4 depicts a schematic of a dual-labeled fluorescent oligonucleotide probe as described in FIG. 3.

FIG. 5 shows a schematic of at least one embodiment according to the present disclosure of the assembled detection unit used in the system.

FIG. 6 shows a top view of the detection unit of FIG. 5.

FIG. 7 shows an exploded view of the detection unit of FIGS. 5 and 6 with various internal components broken away.

FIG. 8 shows passage of light to the CCD under excitation in the detection unit of FIGS. 5-7.

FIG. 9 depicts a graph of temperature vs. time representing a thermal response of a thermal chamber of the system during detection of four genes common to E. coli O157:H7.

FIG. 10 depicts polymerase chain reaction (PCR) products for one of the genes referred to in FIG. 9 (namely hylc).

FIG. 11 shows a schematic of at least one embodiment according to the present disclosure of a fluidic system that can be used with the detection unit of FIGS. 5-7 and utilizes thermocouples (and other sensor systems) to control the temperature of the detection chamber, as well as fluidics controls, valves, pumps, and sensors to control the buffers (and other fluids) in the system.

FIG. 12 shows the schematic of the fluidic system of FIG. 11 depicting the flow of fluids during the mixing cycle.

FIG. 13 shows the schematic of the fluidic system of FIG. 11 depicting the flow of fluids during the first feed line cleaning cycle.

FIG. 14 shows the schematic of the fluidic system of FIG. 11 depicting the flow of fluids during the second chamber cleaning cycle.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one of ordinary skill in the art to which this invention pertains.

A novel system has been developed to enable the detection of deoxyribonucleic acid (DNA) biomarkers in an automated, or a semi-automated process, and operated by non-technical (i.e. non-molecular biologists) personnel. The system can be used to detect DNA biomarker(s). It should be appreciated that a system according to the present disclosure can be used for both (a) qualitative detection, meaning that the system simply detects the presence of one or more DNA biomarkers, and (b) quantitative detection, where the absolute or relative amount of DNA is present within a sample. Furthermore, a detection probe system according to the present disclosure can be used to detect one or more changes or differences in DNA sequence, such as single nucleotide polymorphisms (SNPs).

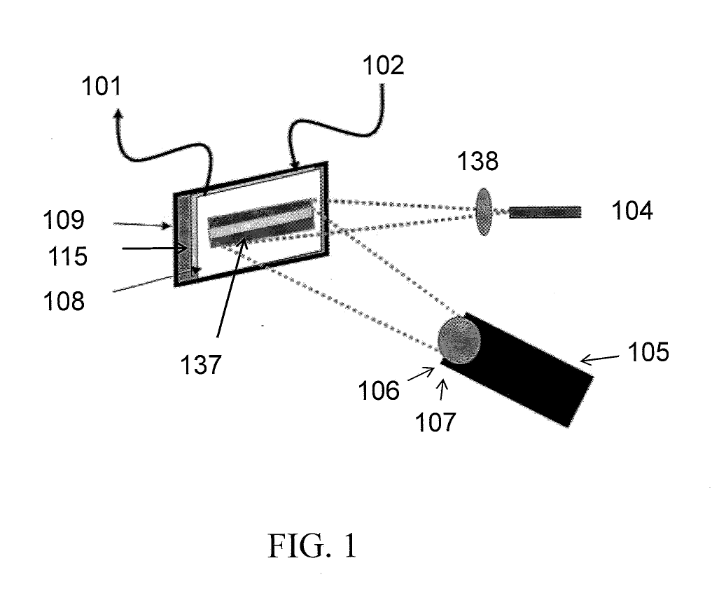

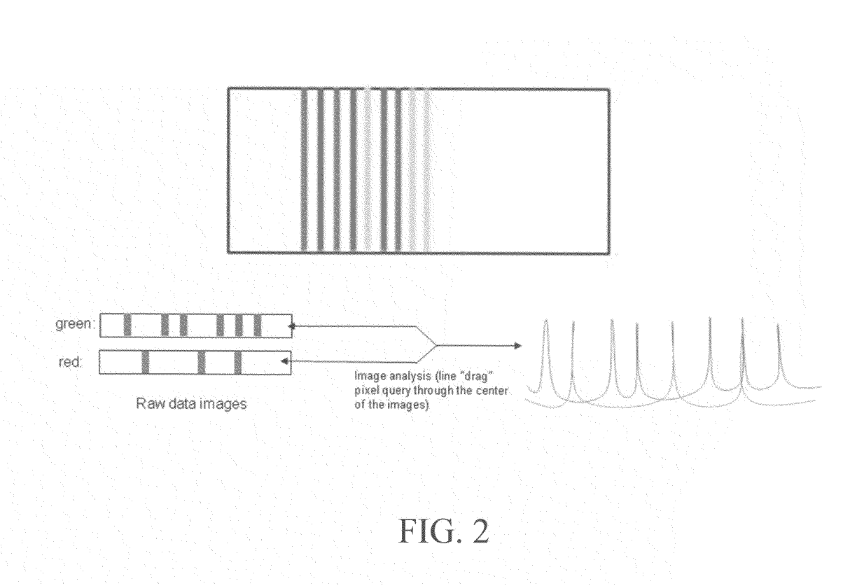

A system according to the present disclosure provides the capability to screen samples within the food processing industry to allow for a rapid, qualitative screening of consumable materials for evidence of pathogenic microorganisms. The purpose of such a system is to screen for DNA sequences that are unique to specific pathogens and provide a warning to a user if evidence of a pathogen is present, based on the detection of these DNA sequences. A schematic of an exemplary embodiment of the system designed for optical emission and detection of DNA sequences is depicted in FIG. 1. The system in FIG. 1 includes a detection device which is designed to reduce the costs associated with 2-dimensional imaging. The system advantageously utilizes a linear charge coupled device (CCD) array 105 that is, in at least one embodiment, perpendicular to the lines 137 created by the placement of the detection device, similar to a barcode reader. The “raw barcode” data collected from the system can be converted via image analysis into a graphical representation, an example of which is demonstrated by the graph in FIG. 2.

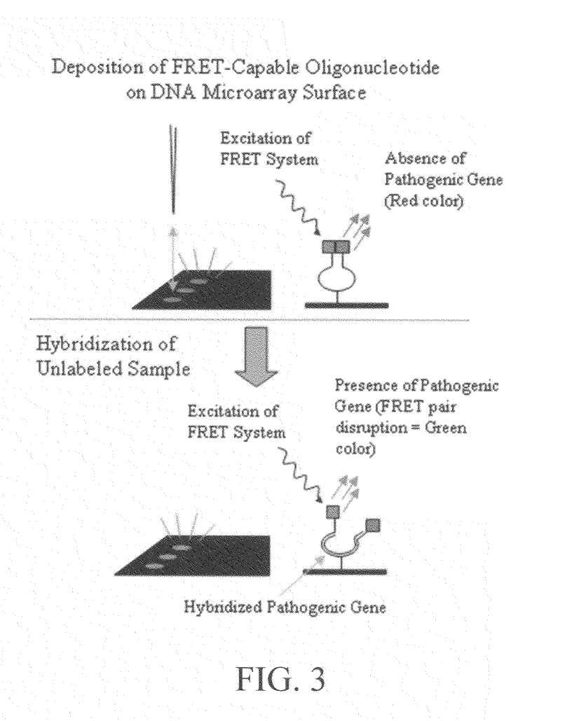

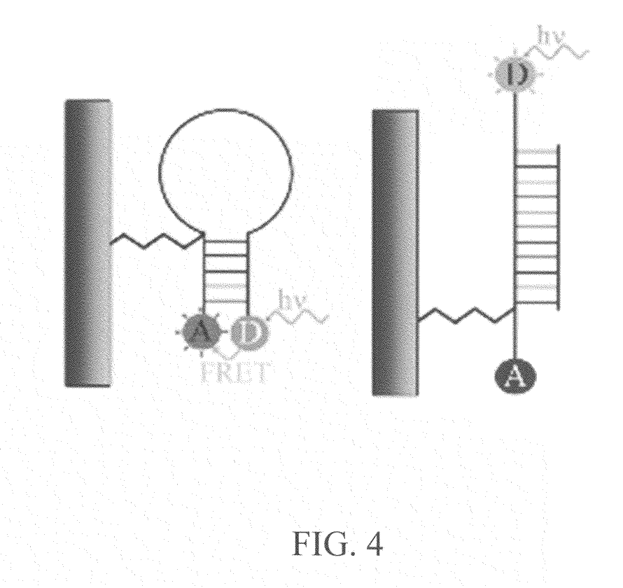

Noteworthy functions of a DNA screening system according to the present disclosure are to (1) amplify the gene region of interest using common thermocycling methods (e.g. polymerase chain reaction (PCR)), and (2) detect a color-change in the fluorescence of the capture probe, all within a single reaction chamber. The system uses a fluorescence-based color change, rather than known methods of detecting presence/absence of fluorescence commonly used in DNA microarray technology, to detect the DNA biomarkers, which significantly reduces the risk of false negative detection in samples. These functions are achieved by generating a specialized microarray that includes dual-labeled fluorescent oligonucleotide probes such as that shown in FIG. 4. As shown in FIGS. 3 and 4, the microarray fluoresces red 422 in the absence of sequence-specific binding, using fluorescence resonance energy transfer (FRET), and fluoresces green 421 in the presence of sequence-specific binding (due to the disruption of FRET). Furthermore, at least one embodiment of the present disclosure is designed to utilize quality controls inherent to the detection probe system that can be verified before, during, and after a sample is analyzed, which provides the system with more rigorous detection parameters than that common to DNA microarray technology, and can be employed to check the integrity of the system after a sample is analyzed and determine if the system can be used to analyze another sample (without changing the probe system).

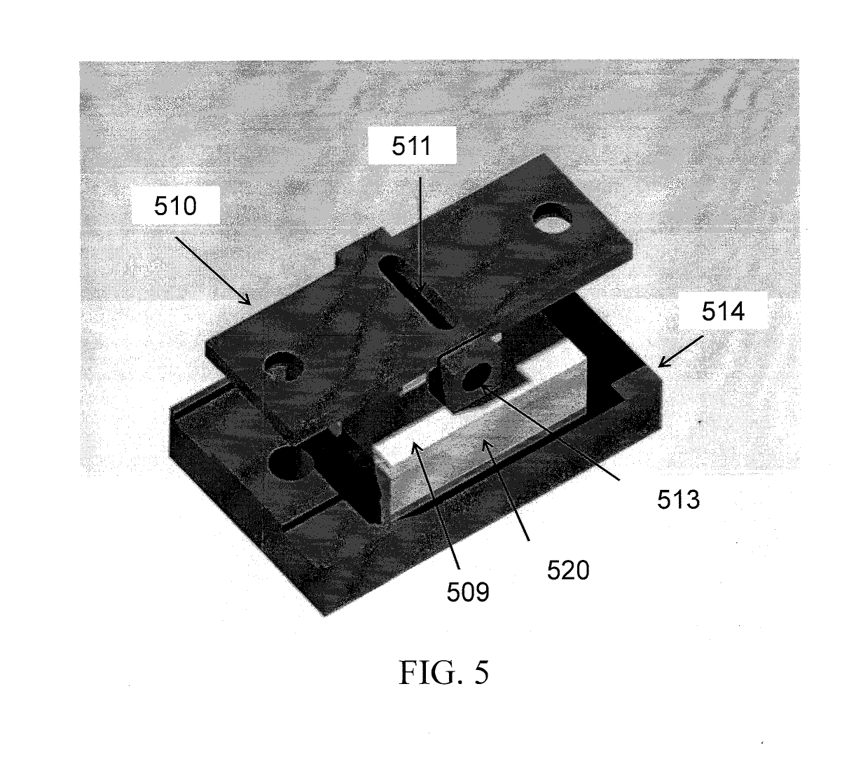

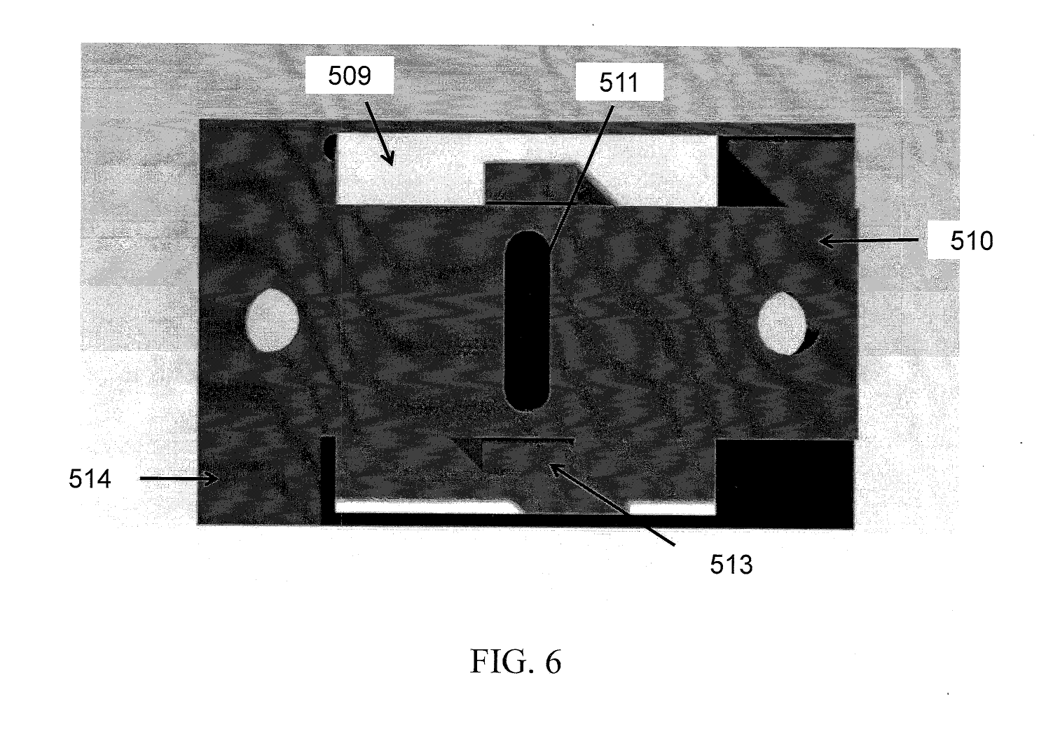

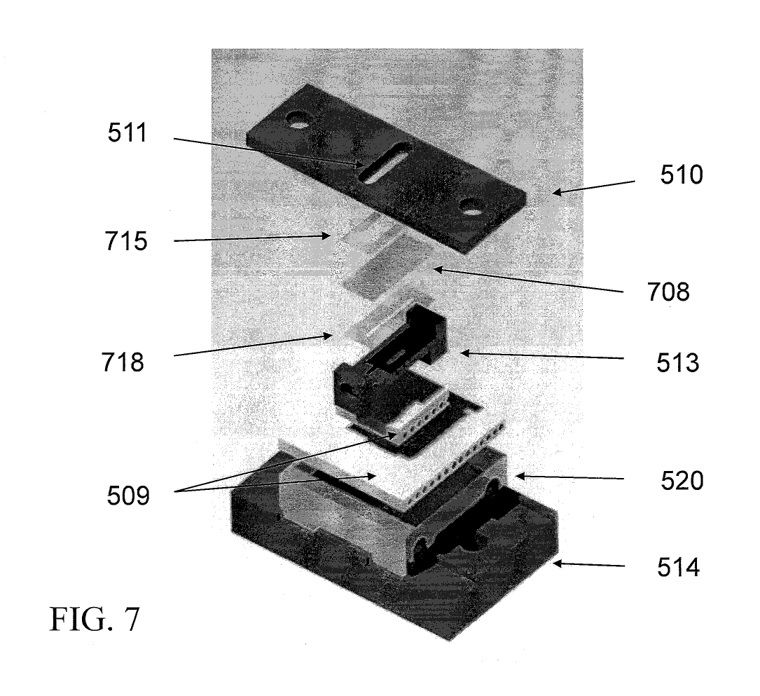

A detection device according to at least one embodiment of the present disclosure is shown in FIGS. 5-7. FIG. 5 shows a perspective view and FIG. 6 shows a top view of a detection device embodiment. FIG. 7 shows an exploded view of the detection device embodiment depicted in FIGS. 5 and 6. Such a detection device comprises a top clamp 510 and a bottom clamp 514 that operably holds together the components of the detection device. The top clamp 510 contains an optical aperture 511, which provides a window to allow for laser-based excitation 104 and CCD-based detection 105, 805 of the oligonucleotide probes on a microarray 108, 708. As shown in FIG. 7, a DNA microarray slide 708 (that contains the dual-labeled fluoro-probes as shown in FIG. 4) is sandwiched between a top clamp cushion 715 positioned under the top clamp 510 and a sealing gasket 718 positioned above a reaction chamber 513. The reaction chamber 513 is where test samples, primers, and/or buffers (e.g., 100 μl in volume) can be introduced. The reaction chamber 513 is configured to provide sufficient volume to perform multiplex PCR (amplifying more than one target DNA sequence at a time).

As indicated by FIG. 1, such a detection device contains inlet 101 and outlet 102 ports on the reaction chamber 513, which are sealed using valves 1223, 1225, 1229 (2 and 3 way Pinch Valve parts available from Biochem Fluidics, such as part numbers 075P2NC12-02S, 075P3MP12-02S, 100PD3MP12-02S).

The reaction chamber 513 may be capable of quickly heating or cooling for PCR-based amplification of the pathogenic gene templates, and can achieve temperatures that open or close the FRET-probe(s) as shown in FIG. 3. The heating and cooling functions of the detection device are achieved using thermoelectric (Peltier) modules 109, 509, which are located between a water block 520 and the reaction chamber 513, as shown in FIG. 5. The thermoelectric Peltier modules 509 and water block 520 (Peltier Heaters (40 mm×40 mm) and (20 mm×20 mm) and Water Block parts available at Custom Thermoelectric, such as part numbers 12711-5L31-05C, 03111-9L31-04CG, and WBA-1.62-0.55-CU-01) are used to perform thermocycling for cell lysis, PCR, and detection. The thermoelectric module 509 is driven via a solidstate relay connected to a DO port on a C Series 9274 module. The temperature of the system is controlled by integrated thermocouples (and other sensor systems, including biosensors) 1131 at the microscope slide surface, which provides precise temperature control of the reaction chamber 513 for real-time temperature readings. The thermocouples 1131 provide a feedback loop by providing heating/cooling signals to the Peltier modules 109, 509 and reaction chamber temperatures. This provides the basic I/O for the development of a control software system and supporting circuit board control system. Temperature control is implemented in LabView using a gain scheduling PI controller.

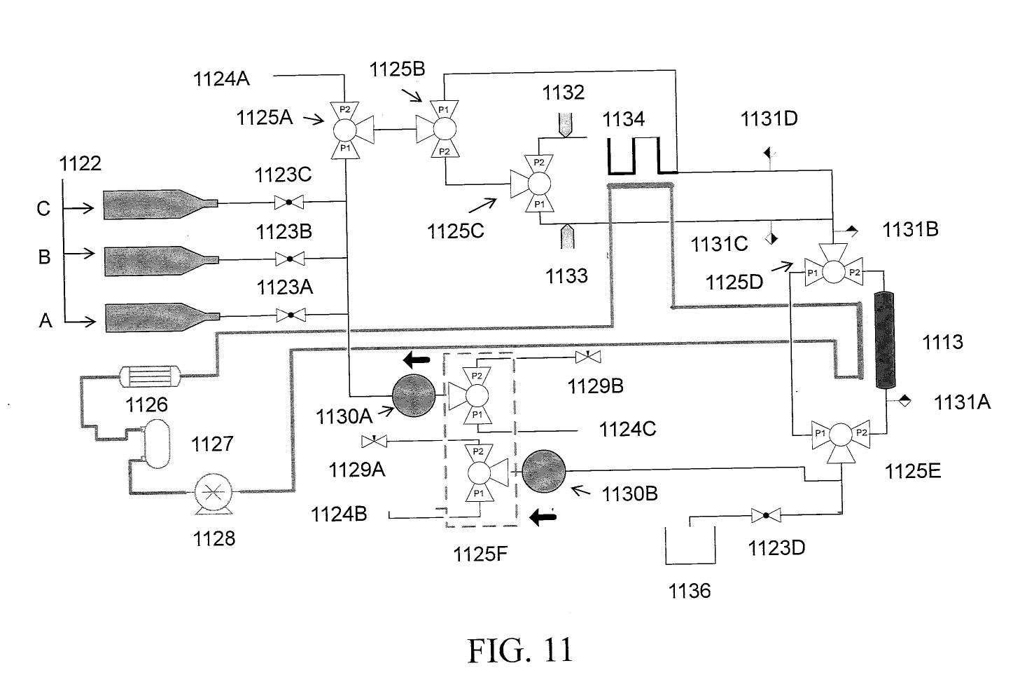

FIG. 11 shows a schematic of an exemplary fluidic system according to at least one embodiment of the present disclosure. As depicted in FIG. 11, the system uses fluidics controls, valves 1123, 1125, 1129, pumps 1130 (Dosing pump parts available from Biochem Fluidics, such as part number 120SP1220-5TV), and sensors 1131 (Tubing fluid sensors available from Newark Components, such as part number 47P7966) to precisely control the buffers (and other fluids) in the system. The fluidic system also contains a set of reservoirs 1122A-C each connected to a valve 1123A-C that can be turned “on” or “off”. The valves 1123A-C are connected to the P1 position of a valve 1125A. When in the P2 position, the valve 1125A is connected to an air line 1124A. The valve 1125A is connected to another valve 1125B. The valve 1125B is connected to the reagent reservoir 1134 via the P1 position and another valve 1125C via the P2 position. Valve 1125C is connected to the reagent dosing point 1132 through the P2 position and the sample dosing point 1133 through the P1 position. The reagent reservoir 1134 is connected to a sensor 1131D. The sample dosing point 1133 is connected to another sensor 1131C. Both sensors 1131C and D are connected to Sensor 1131B, which is connected to a valve 1125D. When valve 1125D is in the P2 position, it is connected to the reaction chamber 1113. When valve 1125D is in the P1 position, it is connected to the P1 position of valve 1125E. The P2 position of valve 1125E is connected to sensor 1131A, which is connected to the reaction chamber 1113. Valve 1125E is also connected to a pump 1130B and a valve 1123D. Valve 1123D is connected to the waste chamber 1136. Pump 1130B is connected to valve 1125F. Valve 1125F is connected via the P2 position to valve 1129A and to an air line 1124B via the P1 position. Pump 1130A is connected to valve 1125F, and valve 1125F is connected via the P2 position to valve 1129B and via the P1 position to an air line 1124C.

Pump 1130A is used to push fluid through the system. Pump 1130B is used to pull fluid through the system. Valve 1125F is a dual tubing 3 way pinch valve. Only air passes through the pumps. All liquids are deposited to waste. With valve 1125F at P1, pump 1130A can use an unrestricted air line to push fluid through the system. With valve 1125F at P2, pump 1130B uses a restricted air line to push fluid through the system and it operates at a lower flow rate. This lower flow rate can be set using the needle valves 1129A and B (Needle valve parts available from Pneuaire Components, such as part number F-28 22-40-B80-K). Pump 1130B operates in a similar manner but with the unrestricted and restricted air lines 1124 connected to the outlet 102 as opposed to the inlet 101, such as shown in FIG. 1.

The fluidic system control software system can be programmed in several states. First, the fluid system can operate for reagent reservoir loading through the activation of the “Reagent Loading” state. In this state, valve 1125D and valve 1125E are set to P1 and Valve 1123D is set to on. Next, the system can be sent into “Begin” state in which input and control parameters (PCR temperatures, etc.) are entered into the system. The system then begins to verify the probes by setting Valve 1123A to on, valve 1123D to Off, and valves 1125A, B, D, and E are set to P1. Pump 1130B then switches “on” until a requisite amount of buffer/rinse is drawn from reservoir 1122A. Then, valve 1123A is set to off, valve 1123D is set to on, and pump 1130A is switched on. When fluid triggers sensor 1131B, valves 1125D and E switch to P2. When fluid triggers sensor 1131A, pump 1130A is switched “off” and valves 1125D and E switch to P1. After this step, the laser 104 and CCD 105 are activated and the fluorescence emission spectrum is logged.

The laser 104 and CCD 105, such as shown in FIG. 1, are then deactivated, which activates the heater 109, 509, such as shown in FIGS. 1 and 5. Once the detection temperature is reacted, the laser 104 and CCD 105 are reactivated and the fluorescence emission spectrum is logged again. The laser 104 and CCD 105 are again deactivated along with the heater 109, 509. At this time, valves 1125D and E switch to P2 and pump 1130A is switched “on” until liquid deposited in waste chamber 1136. Valves 1125D and E then switch to P1. At this point, the device can proceed to the “Sample Loading” state unless the system has found that the probes are damaged. The user is then prompted to load a sample for the “Sample Loading” state, and the system will notify the user once loading is complete. Valves 1125A and B are then switched to P2 and valve 1125C is switched to P1. Pump 1130B is switched “on” until sensor 1131C is triggered. The reagents are then metered in the device during the “Reagent Metering” state by switching valve 1125C to P2 and switching “on” pump 1130B until sensor 1131D is triggered.

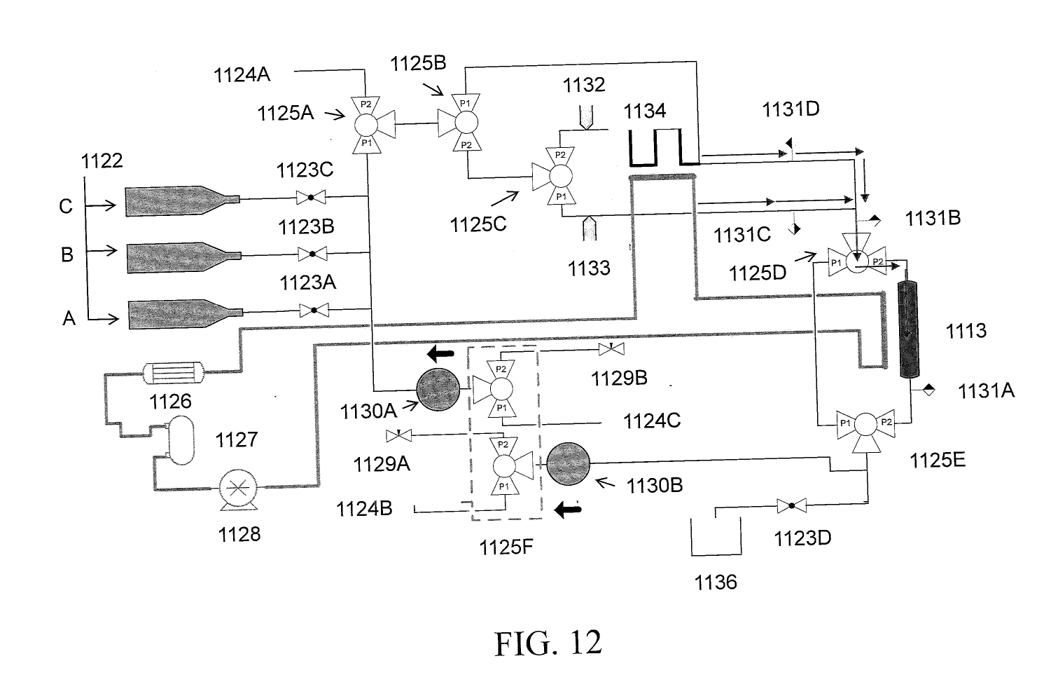

As depicted in FIG. 12, after the “Reagent Metering” state, the device enters the ‘Mixing’ state. Mixing occurs in the device through switching valve 1125A to P1 and valve 1125F to P2. When pump 1130A is switch on, valve 1125C switches between P1 and P2. As shown with arrows 1137A, fluid then activates sensor 1131C, and valves 1125D and E are switched to P2. Fluid then activates sensor 1131A, pump 1130 A switched off, and valves 1125D and E are switched to P1.

The PCR reaction then takes place within the device through the activation of the heater 109, 509 and temperature cycling during the “PCR Cycling” state. After the specified cycle number has been reached, the reaction chamber 513 is set to the detection temperature. This activates the laser 104 and CCD 105 and the fluorescence emission spectrum is logged. The laser 104 and CCD 105 are then deactivated and the reaction chamber 513 can be returned to temperature cycling. The above is repeated until end of PCR cycling.

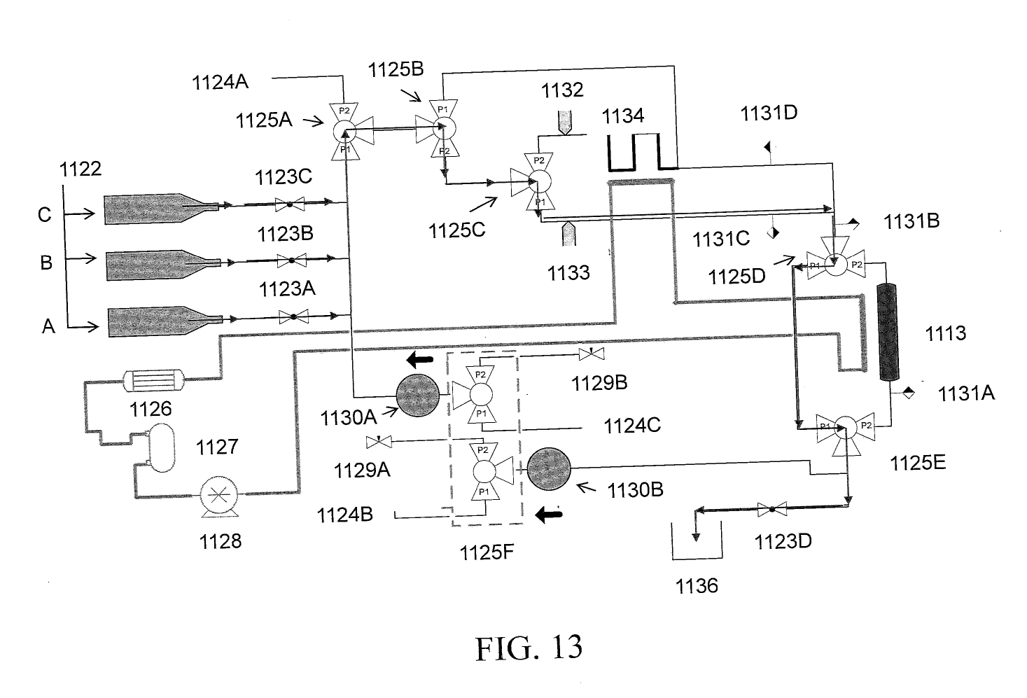

As depicted in FIG. 13, during the “PCR Cycling” state, the feed line can be cleaned during the “Feed Line Cleaning” state by setting valves 1125A, C, D, and E to P1, and valve 1125B is set to P2. Valve 1123A is then set to “on” and valve 1123D is set to off. This activates pump 1130B until requisite amount of detergent is drawn from reservoir 1122C. Once this occurs, valve 1123A is set to off, valve 1123D is set to on, and pump 1130A is switched on. As shown by arrows 1137B, fluid is then pushed through system to a waste chamber 1136. The above is repeated for detergent in reservoir 1122B and buffer/rinse in reservoir 1122A.

During PCR cycling after detection has begun, real time data logging and analysis can be performed. The device presents the user with a graph of the logged fluorescence emission spectra. The device then performs a numerical analysis on the fluorescence emission spectra providing the user with numerical value (+/−) for the increase or decrease in fluorescence intensity for each target DNA sequence in both green and red. The device writes the chamber temperature and fluorescence spectra to spread sheet files. The user is alerted automatically of any positive targets. A control action can then be performed automatically by the device or manually by the user.

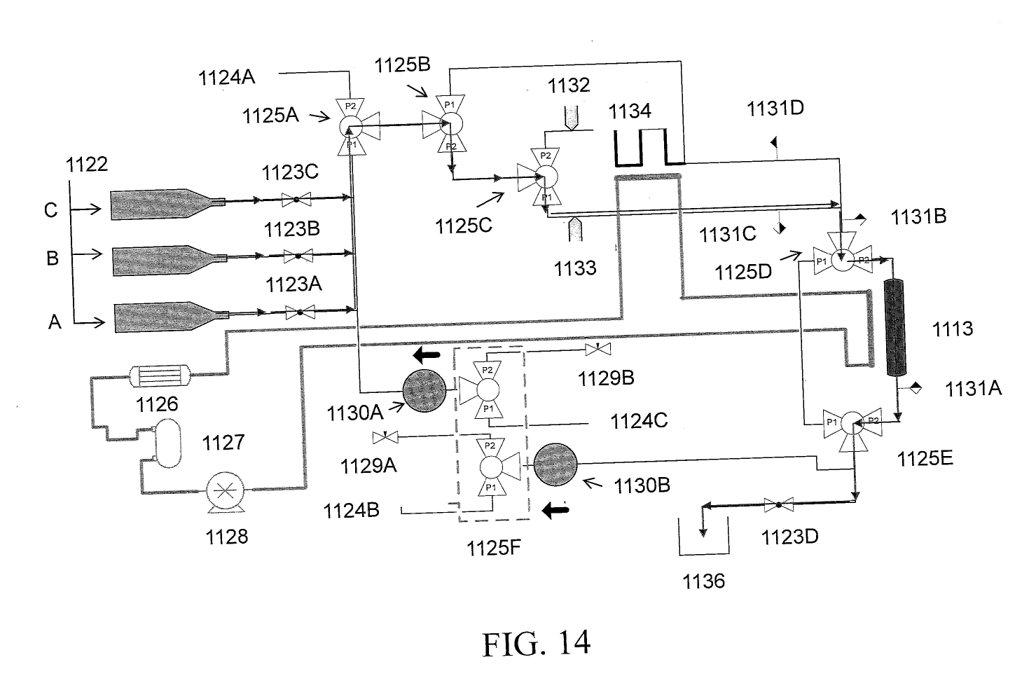

Upon completion of PCR cycling, the device enters “Reaction Mixture Removal” state. During this state, valves 1125D and E are set to P2 and valve 1123D is set to on. Pump 1130A then switches “on” until the reagent is sent to waste chamber 1136 or collected by the user via the tapping point. After this, the device enters “Chamber Cleaning” state as shown in FIG. 14 where the device can self-clean the chamber via the steps for “Feed Line Cleaning” followed by switching valves 1125D and E to P2, shown by arrows 1137C. After this step, the device returns to “Probe Verification” state unless the user overrides the device and sends it to “End State” or the device automatically moves to “End State” due to lack of reagent.

In operation, a sample is collected and prepared and is to be suspended in a liquid volume of 25 μl. The sample is loaded into the fluidics system, as shown in FIGS. 11-14, of the detection device using a standard pipette. The sample dosing point 1132, such as shown in FIG. 11, consists of a manually removable cap allowing direct access to a tubing line. The cap is reattached once loading is complete. The 25 μl sample volume is mixed with a 75 μl volume containing the PCR reagents (primers, buffers, polymerase etc.) to give a total reaction volume of 1004 As shown in FIG. 12, mixing is achieved by alternating flow from the sample and reagent lines using a valve system 1123, 1125, 1129 and pumps 1130. The 75 μl volume is drawn from a reservoir 1122 held at a temperature of 4 degrees Celsius to prevent degradation. The temperature of the reaction chamber 513, as shown in FIG. 5, is controlled using a thermocouple 1131 while varying the voltage (and polarity) applied to the thermoelectric heater 509, as shown in FIG. 5. A water block 520 attached to one side of the thermoelectric heater 509, such as shown in FIG. 5, allows for a more stable operation of the heater. The water block 520 is connected to a radiator cooling system, shown in FIGS. 11-14, consisting of the radiator 1126, the cooling system reservoir 1127, and the cooling system pump 1128.

The 100 μl reaction volume is then deposited into the reaction chamber 513, 1113. The inlet 101 and outlet 102 ports, such as shown in FIG. 1, of the chamber are then sealed by valves 1123, 1125, 1129. The reaction volume is heated to 95 degrees Celsius to ensure cell lysis (where whole cells are introduced in the sample volume). Temperature is monitored by a thermocouple 1131 embedded in the reaction chamber 513, 1113 wall.

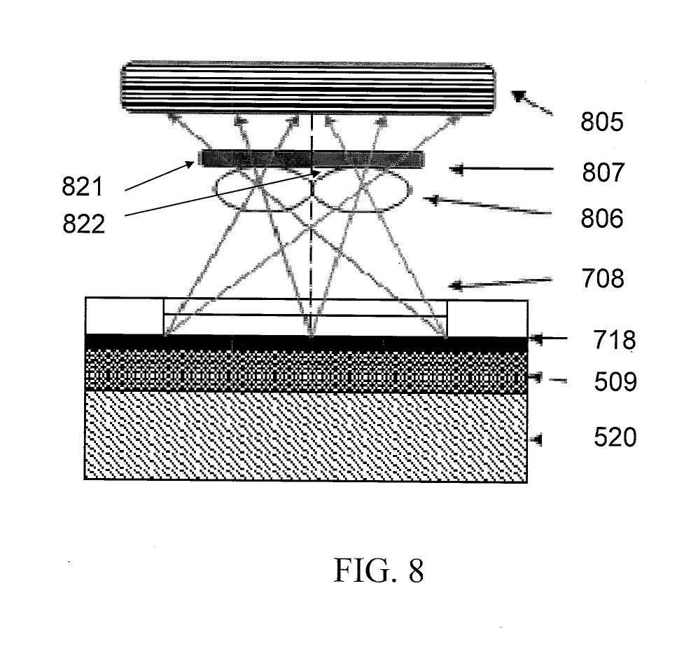

Following this step a standard PCR thermocycling takes place. The number of cycles, denaturing, annealing and extension temperatures, final elongation and holding temperatures (if required) can be set by the user. The user can also input the number of cycles required before detection begins and detection temperature(s) (if required). When a pre-determined number of cycles have occurred, the sample is held at a detection temperature. As shown in FIG. 1, the oligonucleotide probes on the microarray are excited using a five milliwatt 532 nm laser 104 (532 nm DPSS Green Laser Module parts available from Lasermate, such as part number GMP-532-20F3-CP) spread into a line 137 by a plano concave lenses 138 (parts available from Thorlabs, such as part number LB1450-A). As shown in FIGS. 1 and 8, fluorescence is detected by focusing a double image of the microarray 108, 708 onto a 2048 pixel linear CCD 105, 805 (2048 Element Linear CCD array parts available from Ames Photonics Inc, such as part number Larry 2048) via two spherical lenses 106, 806 (parts available from Thorlabs, such as part number LB1450-A), with one half of the image filtered in red 821 and one half in green 822 (568 nm and 671 nm Band Pass Filters, available from Edmund Optics, such as part numbers NT43-127 and NT43-139). FIG. 8 shows passage of light to the CCD 805 under excitation in the detection device of FIGS. 5-7. The emission intensity spectrum taken after each detection step is stored on the control computer. Analysis of the change in the ratio of green to red fluorescence is used to indicate whether a test sample is positive or negative for the target DNA (See FIG. 2).

After completion of the PCR and detection cycles, the reaction volume is removed from the reaction chamber 513, 1113. It can be sent directly to a waste chamber 1136 or collected by the user via a tapping point as shown in FIGS. 11-14. The cleaning cycle begins while the PCR and detection steps are running. The sample loading line and mixing line are cleaned using a three step cleaning cycle. As shown in FIG. 13, the detergents and rinsing fluid are drawn from reservoirs 1122. The spent fluid is deposited in the waste chamber 1136 via a line running parallel to the reaction chamber 513, 1113, see arrows 1137B. This reduces the amount of contamination entering the chamber between test runs. Upon removal of the reaction volume from the reaction chamber 513, 1113, the same three step cleaning cycle is conducted in the chamber itself and deposited to the waste chamber 1136 (See FIG. 14, arrows 1137C). The operation of the probes is then verified as described above. The operation of the oligonucleotide probes is checked after the cleaning cycle to ensure they are functioning correctly. The operator is alerted in case of a malfunction and an appropriate action is taken. The above described steps are then repeated.

### EXAMPLE

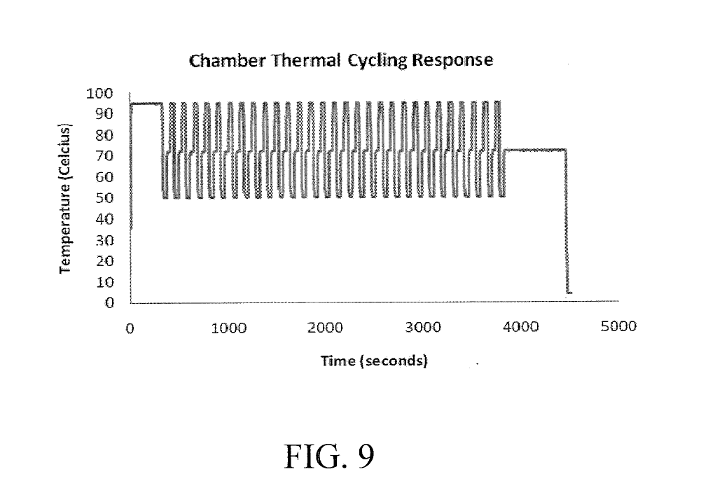

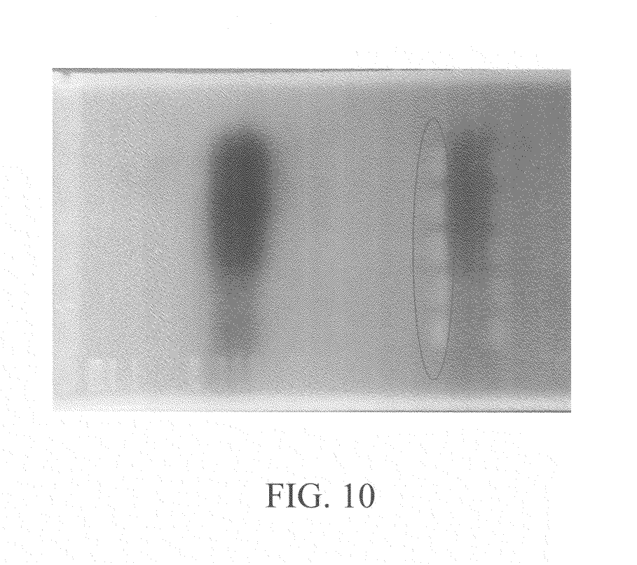

Four genes common to E. coli O157:H7 were selected for detection by the system. These genes are eaeA, hlyc, rfbE and stx1. To test the functionality of the reaction chamber 513, 1113 in amplifying these DNA sequences, 100 μl samples each containing target DNA and the relevant primers and buffers were prepared. Each sample was loaded into the reaction chamber 513, 1113 sequentially and underwent a 30 cycle PCR with temperature stages at 95° C., 50° C., 72° C. respectively. There was a 5 minute hold at 95° C. before cycling and a 10 minute hold at 72° C. after cycling after which the sample was cooled to 4° C. and removed from the reaction chamber 513, 1113. The thermal response of the reaction chamber 513, 1113 is shown in FIG. 9. The overall reaction time was less than 80 minutes with maximum heating and cooling rates of 2.3° C./s and 3.1° C./s, respectively. The faster cooling rate was achieved by changing the polarity of the voltage supplied to the thermoelectric heater 509. Gel electrophoresis was performed on each sample after PCR, an example of which is shown in FIG. 10, using a 1 kb ladder to confirm amplification had occurred.

After studying the present disclosure, those skilled in the art will recognize that numerous modifications can be made to the specific implementations of the detection system described above. Therefore, the system is not to be limited to the specific embodiments illustrated and described above. The system, as originally presented and as it may be amended, encompasses variations, alternatives, modifications, improvements, equivalents, and substantial equivalents of the embodiments and teachings disclosed herein, including those that are presently unforeseen or unappreciated, and that, for example, may arise from applicants/patentees and others.

We claim:

1. A method of detecting DNA biomarkers comprising the steps of:
loading a volume of amplification reagents into an automated detection device;
entering at least one control parameter into the automated detection device;
loading a sample into the detection device;
mixing the sample with the amplification reagents to create a reaction volume;
conducting at least one thermal cycle on the reaction volume;
hybridizing the reaction volume to the at least one dual-fluorescent oligonucleotide probe;
detecting a fluorescence emission, wherein the at least one dual-fluorescent oligonucleotide probe hybridized to the reaction volume is excited by a laser and emits a fluorescence detected by an emission detector;
logging data from the fluorescence emission;
analyzing the data from the fluorescence emission;
automatically cleaning the automated detection device; and
conducting a verification test, wherein at least one dual-fluorescent oligonucleotide probe is excited by a laser and emits a fluorescence detected by an emission detector.

2. The method of claim 1, further comprising the step of conducting a second verification test prior to loading the sample.

3. The method of claim 1, where the reaction volume is at least 100 μl.

4. The method of claim 1, where the fluorescence is red or green.

5. The method of claim 2, where the fluorescence is red or green.

6. The method of claim 1, where the step of automatically cleaning the automated detection device occurs concurrently with the step of conducting at least one thermal cycle on the reaction volume and the step of detecting a fluorescence emission.

7. The method of claim 1, further comprising the step of:
holding the reaction volume at a detection temperature to hybridize the reaction volume to the at least one dual-fluorescent oligonucleotide probe.

8. The method of claim 1, where the step of automatically cleaning the automated detection device comprises three discrete cleaning cycles.

9. An automated DNA detection device comprising:
a top clamp having an optical aperture;
a microarray slide connected below the top clamp, the microarray slide comprising at least one dual-labeled fluorescent oligonucleotide probe, wherein the optical aperture of the top clamp allows for a fluorescence emission of the at least one dual-labeled fluorescent oligonucleotide probe and emission detection by an emission detector;
a reaction chamber connected to the microarray slide, the reaction chamber comprising a reaction volume;
a thermoelectric module connected to the reaction chamber, wherein the thermoelectric module is capable of heating or cooling the reaction volume;
a water block connected to the thermoelectric module, wherein the water block and the thermoelectric module operate to perform at least one thermal cycle;
a fluidic system in communication with the water block, thermoelectric module, reaction chamber, laser, and emission detector, wherein the fluidic system comprises at least one reservoir, waste chamber, cooling system, valve, pump, and sensor operably connected to one another to control the flow of at least one fluid through the fluidic system, wherein the at least one sensor can detect the flow of the at least one fluid within the fluidic system and provide at least one feedback communication to the emission detector; and
a bottom clamp operably connected to the top clamp to secure the microarray slide, reaction chamber, thermoelectric module, water block, and fluidic system to one another.

10. The automated DNA detection device of claim 9, further comprising at least one gasket.

11. The automated DNA detection device of claim 9, wherein the fluidic system comprises three reservoirs.

12. The automated DNA detection device of claim 9, wherein the at least one feedback communication comprises a quality control communication.

13. The automated DNA detection device of claim 9, wherein the at least one feedback communication comprises a self-cleaning communication.

14. The automated DNA detection device of claim 9, wherein the at least one feedback communication comprises a probe verification communication.

15. The automated DNA detection device of claim 9, wherein the detection device is reusable.

16. A method of detecting DNA biomarkers comprising the steps of:
loading a volume of amplification reagents into an automated detection device;
entering at least one control parameter into the automated detection device;
conducting a first verification test, wherein at least one dual-fluorescent oligonucleotide probe is excited by a laser and emits either a red or a green fluorescence detectable by an emission detector;
loading a sample into the detection device;
mixing the sample with the amplification reagents to create a reaction volume;
conducting at least one thermal cycle on the reaction volume;
holding the reaction volume at a detection temperature to hybridize the reaction volume to the at least one dual-fluorescent oligonucleotide probe;
detecting a fluorescence emission, wherein the at least one dual-fluorescent oligonucleotide probe hybridized to the reaction volume is excited by the laser and emits either the red or the green fluorescence detected by the emission detector;
logging data from the fluorescence emission;
analyzing the data from the fluorescence emission;
automatically cleaning the automated detection device;
conducting a second verification test; and
repeating each of the foregoing steps at least one time.
